(19) United States
(12) Patent Application Publication
(10) Pub. No.: US 2004/0251290 A1
(43) Pub. Date: Dec. 16, 2004

(54) Cutting method for brittle non-metallic materials (two variants)

(76) Inventor: Vladimir Stepanovich Kondratenko, Moscow (RU)

Correspondence Address: Testa Hurwitz & Thibeault, Patent Administrator, 125 High Street, Boston, MA, 02110-2704, US

(21) Appl. No.: 10/484,987

(22) PCT Filed: Jul. 2, 2002
(86) PCT No.: PCT/RU02/00318

(30) Foreign Application Priority Data
Jul. 25, 2001 (RU) 2001120746

(51) Int. Cl. B26F 3/00

(52) U.S. Cl. 225/2; 219/121.72; 225/96

(57) ABSTRACT

The aim of present invention is to improve the efficiency and quality of the cutting of brittle non-metallic materials. In the first variant, the inventive method for cutting brittle non-metallic materials consisting in notching along cutting line and in additionally acting on the surface of the material, is characterised in that the additional action on the surface of the material is performed with at least one elastic wave source in the area of the notch, the amplitude and frequency of elastic waves are selected according to a condition of deepening the notch to the predetermined depth or cutting through said material. In the second variant, the notching is performed by heating the material surface along the cutting line with the aid of a laser beam elongated therealong and by locally cooling the heated area. The additional action on the material surface is performed by successively cooling each point of the cutting line in the heating area during a period of time commensurable with the time for heating said point. The cooling time is selected in relation to the material thickness and the thermophysical properties thereof according to a condition of producing the cut having the predetermined depth.

This invention relates to methods for cutting brittle non-metallic materials, including laser cutting materials such as all types of glass, including quartz glass; various monocrystalline materials, such as sapphire and quartz; all types of ceramics, as well as semiconductor materials.

Known in the art is a method for cutting brittle non-metallic materials including scribing the surface of the material along the path of the cut, heating the scribe using a laser beam while moving the beam and the material relative to each other, and locally cooling the heated area using a cooling medium (RF Patent No. 2024441, MKI⁵ C 03 B 33/02, publ. 15.12.94).

This method may be used not only to scribe, but also to cut through the glass or other brittle non-metallic material by reheating the path of the cut with a laser beam or other heating source.

The drawback of this cutting method is its inefficiency, because, due to low thermal conductivity of glass, the crack can only propagate deep into the material when the beam moves slowly enough across the surface to allow for sufficient heat penetration through the thickness of the material.

Known in the art is a method for cutting non-metallic materials including heating the path of the cut with a laser beam while moving the beam and the material relative to each other, locally cooling the heated area using a cooling medium, and then heating the surface of the material along the path of the cut using two parallel laser beams. (U.S. Pat. No. 6,259,058, IC 7B 24 Cl. 26/067, publ. 10.07. 2001). As in the previous cutting method, reheating can propagate the crack all the way through the entire thickness of the material. However, this method suffers from the same drawbacks as the previously described cutting method.

Known in the art is a method for cutting brittle non-metallic materials using an apparatus for laser processing brittle materials that includes heating the surface of one side of a sheet of the material with a laser beam to form a through crack and additionally applying a mechanical force on the surface of the opposite side of the sheet (RF Patent No. 2139779, IC B 23 Cl. 26/00, publ. 20.10.99).

However, neither the method of applying constant mechanical force on the opposite side of the surface of the material, nor the method of tapping a movable ball on the surface of the opposite side of the sheet along the path of the laser beam, are capable of accelerating the cutting process. These methods only decrease the lag between the position of the crack and the position of the laser beam along the surface of the material.

Also known in the art is a method for cutting sheets of brittle non-metallic materials based on the application of the methods listed above, namely: first forming a scratch (a defect) using a diamond tool along the path of the cut; heating the path of the cut with an elliptical laser beam while moving the beam and the material relative to each other; and locally cooling the heated area using a cooling medium (International Application No. PCT/RU94/00276, Publication No: WO 96/20062, 1996). This method can be used to cut sheets of material along rectilinear as well as any curvilinear paths. Known in the art is a method for cutting sheet glass that includes impinging a directed thermal beam along the path of the cut on one side of the glass surface, thereby forming a through crack, and applying a bending force to the opposite surface, thereby propagating the crack along the path of the cut (U.S. Pat. No. 4,190,184, IPC C 03 B 33/02, priority date 23.08.78).

However, it is not possible to achieve single pass separation of materials at high production capacity using these methods, because final splitting apart of the cracked material requires application of an additional mechanical or other type of breaking force. Such methods cannot achieve high quality of the cut pieces and, furthermore, require additional breaking equipment.

The method of cutting glass that comes closest in its technical essence to the method of the present invention includes forming a scribe in the material along the path of the cut and, in addition, impinging acoustic oscillations on the glass surface, wherein such acoustic oscillations are induced in the direction parallel to the glass surface. (USSR Author's Certificate No. 996347, MKI⁵ CO3 B33/02, publ. 15.02.83). In this method, formation of the through crack in the material is facilitated by exciting acoustic oscillations in the glass in the 2-5 kHz ultrasound range in the direction parallel to the glass surface after scribing the material. In order to increase effectiveness of the process, the frequency of acoustic oscillations is matched to the natural oscillation frequency of the glass, resulting in resonant oscillation.

However, a number of very significant drawbacks prevent broad industrial application of this method. First, inducing ultrasonic oscillations capable of splitting the glass along the scribe line made with a cutting tool in the whole sheet of glass requires substantial expenditure of energy. Second, this cutting process is slow, because it consists of separate temporally spaced production processes: scribing, setting up the vibrator at a precisely determined site relative to the scribe line, firmly attaching the vibrator to the glass surface to ensure close contact, and using a magnetostrictive or a piezoelectric transducer. Furthermore, each cut changes the dimensions of the glass material, necessitating recalculation of frequency of acoustic waves required for resonance effect. This requires labor-intensive preliminary estimates and constant adjustment of vibration frequency. Third, close contact between the vibrator and the glass surface damages the surface creating scratches and shards, and results in a large waste rate.

It is an object of the present invention to improve efficiency and quality of the process of cutting brittle non-metallic materials by providing methods for making separating and non-separating cuts in single or multiple production cycles while maintaining a uniform cutting rate, enabling formation of crosscuts, as well as cutting two-layer laminated materials.

The present invention discloses two methods for achieving the stated objective.

In one aspect, the object of the invention is met by a method for cutting brittle non-metallic materials including forming a scribe along the path of the cut and additionally acting on the surface of the material that is characterized by the additional action on the surface of the material being performed in the area of scribe formation using at least one source of elastic waves, the amplitude and frequency of elastic waves being selected to either deepen the scribe to a predetermined depth or to cut through the sample. Scribing along the path of the cut can be done with a cutting tool, with a laser beam, or by heating the surface of the material along the path of the cut with a laser beam and additionally cooling the heated area with a cooling medium while impinging elastic waves in the area of application of the cooling medium. The scribe line can be formed along the path of the cut by heating the surface of the material along said path with two laser beams impinging on the surface of the material at a given distance from each other in the direction perpendicular to the direction of the relative motion of the laser beams and the material. In this method, the primarily elastic waves are concentrated within the body of the material in the area of scribe formation. The source of elastic waves is preferably the radiation emitted by a pulse laser for which the material is opaque.

The cutting tool can be a diamond pyramid having a cutting face at an angle of 70-140 angular degrees or a rotating hard-alloy roller with a grinding angle of 70-140 angular degrees.

Elastic waves may be induced along the scribe line, for example, after scribing is complete, or only in the predetermined areas of the material along the path of the cut. The method provides for the line of action of the elastic wave source and the path of the cut being displaced relative to each other in the plane perpendicular to the material surface in order to produce a slanted cut.

In some embodiments, two elastic waves impinge simultaneously on opposite sides of the path of the cut on the scribed side of the surface downstream from the scribing tool. Or, simultaneously, one elastic wave may impinge within the body of the material in the area of scribe formation, acting on the opposite surface of the material in the area located between the areas of impingement of two other elastic waves acting on the scribed side of the surface.

In another aspect, the scribing is performed by heating the surface of the material along the path of a cut formed thereon by using a laser beam, and locally cooling the heated area. The additional action on the surface of the material includes subsequent cooling of each point on the path of the cut in the heated area for a period of time commensurate with the duration of heat application at that point. The selection of the cooling time is based on the thickness of the material and the thermophysical properties thereof in order to produce a cut having a predetermined depth.

The subject matter of the invention can be illustrated with reference to the drawings, depicting:

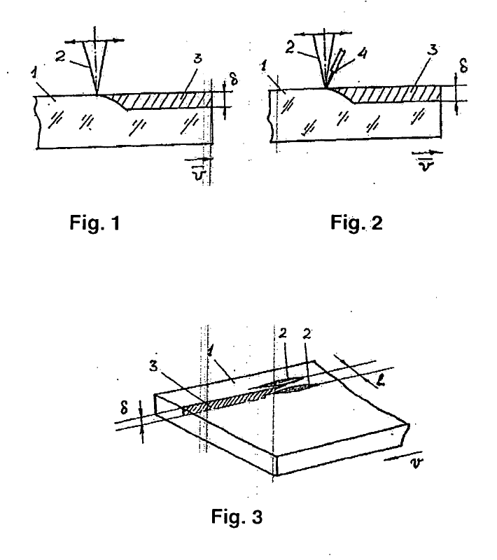

FIG. 1 is a schematic representation of scribe formation in the material with a laser beam;

FIG. 2 is a schematic representation of scribe formation with a laser beam and a cooling medium;

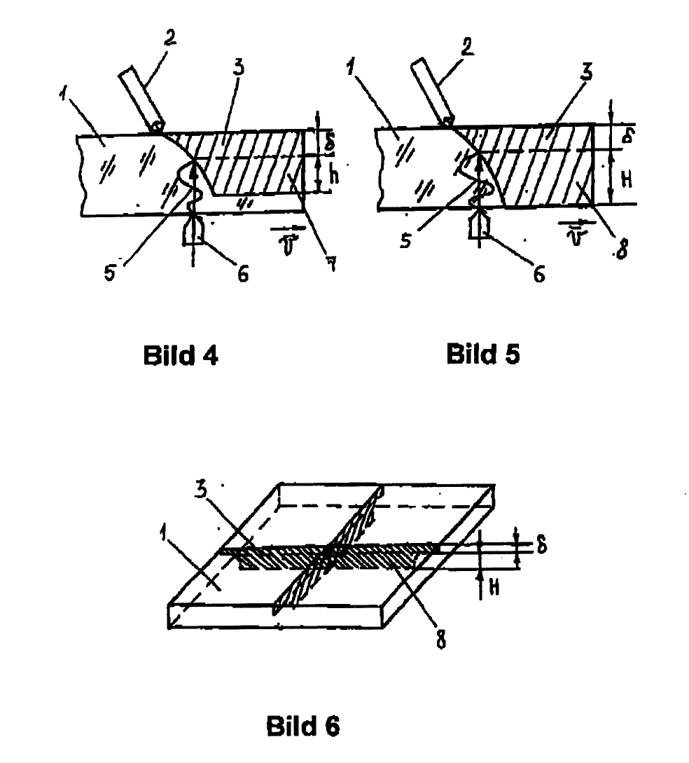

FIG. 3 is a schematic representation of scribe formation in the material with two laser beams;

FIG. 4 is a schematic representation of using elastic waves to extend to a predetermined depth a scribe line made in the material with a cutting tool;

FIG. 5 is a schematic representation of using elastic waves to deepen the scribe achieving a separating cut;

FIG. 6 is a schematic representation of performing in one cycle a separating and non-separating cut and two separating crosscuts;

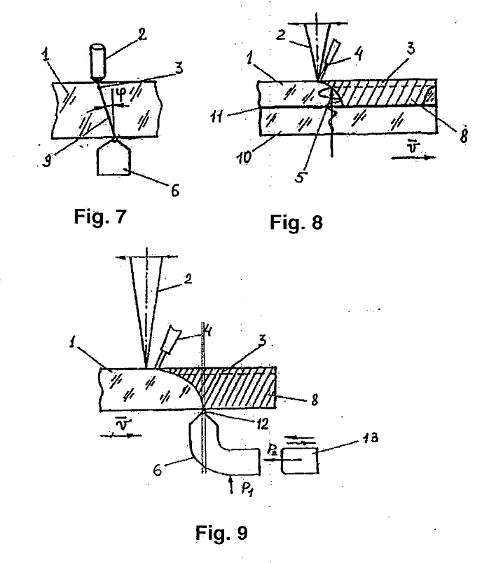

FIG. 7 is a schematic representation of performing a slanted cut relative to the surface of the material;

FIG. 8 is a schematic representation of making a separating cut of one of the two laminated plates;

FIG. 9 is a schematic representation of making a separating cut using a mechanical waveguide and an elastic wave concentrator which are located on the opposite side of the cut sheet;

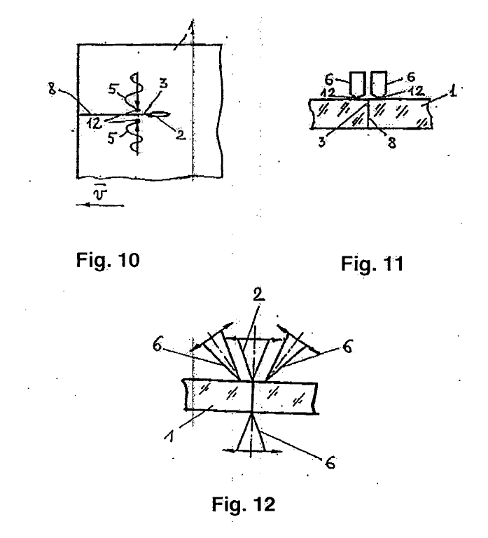

FIG. 10 is a schematic view of a making a separating cut using two laser beams and two elastic wave concentrators, top view;

FIG. 11 is a schematic view of a making a separating cut using two laser beams and two elastic wave concentrators, front view (cross-section);

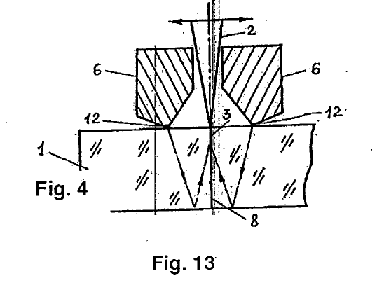

FIG. 12 is a schematic view of making a separating cut with three elastic waves, front view (cross-section);

FIG. 13 is a schematic representation of an elastic wave concentrator acting from the scribed side of the surface;

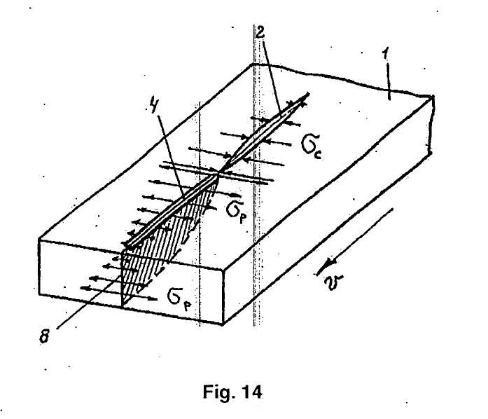

FIG. 14 is a schematic representation of using elongated cooling device to make a separating cut in the material;

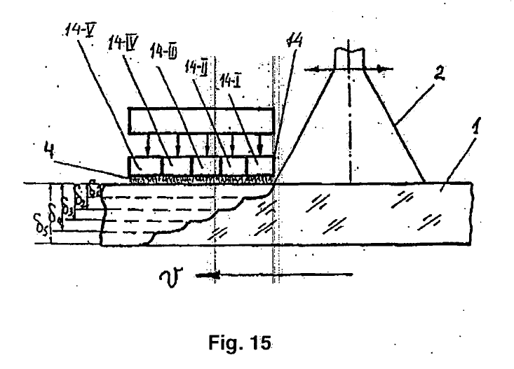

FIG. 15 is a schematic representation of making a controllable cut of a predetermined depth in the material using a multi-stage cooling process.

In one aspect, the method of cutting brittle non-metallic materials includes the following.

Device 2, moving at a relative speed ν with respect to the surface of glass or other brittle non-metallic material 1, acts on the surface to form a scribe line 3 having a depth δ in the body of the material.

According to the invention, device 2 can be a laser beam (FIG. 1), a cutting tool (FIG. 4), two laser beams impinging on the surface of the material at a given distance from each other in a direction perpendicular to the direction of the relative motion of the laser beams and the material (FIG. 3), and other similar devices. The scribe line can be formed, for example, by heating the surface with laser beam 2 and locally quenching the heated area using cooling medium 4 (FIG. 2).

A principal distinctive feature of the first aspect of the invention is the concentration of elastic waves 5 in the body of the material 1 in the area of scribe formation 3. The source 6 can be a concentrator or, for example, a pulse laser for which material 1 is opaque.

It should be emphasized that in this embodiment there is substantially no noticeable mechanical force being applied to the material surface, or any material vibration. Moreover, depending on the parameters of the elastic wave (amplitude and frequency of oscillations) that relate to the main scribing parameters—its speed and depth δ of the scribe line—the scribe line can be deepened to crack 7 having predetermined depth h. By changing the process parameters, it is easy to produce separation cut 8 having depth H.

The fundamental physical principles of elastic wave formation and propagation in elastic solids, and the conditions under which a scribe line can be extended all the way down to a separating cut through the action of elastic waves in the scribe formation area are as follows.

An elastic wave propagating through a solid creates mechanical deformations of stress/strain and shear that are transferred by the wave from one point of the material to another. Energy transfer occurs through elastic deformation within the solid. Two types of elastic waves, longitudinal and shearing, can propagate in an isotropic solid. Deformations from longitudinal waves are a combination of stress/strain and shear. Deformation created by shearing waves is pure shear. Elastic waves are characterized by amplitude, direction of oscillations, variable mechanical stress and deformation, frequency of oscillations, wavelength, phase and group velocities, and the law of distribution of displacements and stresses along the wave front. These parameters should be considered when determining the optimal conditions for crack propagation, in particular the concentration of the elastic wave within the body of the material in the scribe area.

Acoustic waveguides can be used to transfer elastic waves from the source to the scribe area. For example, solid acoustic waveguides, such as plates or rods, can propagate waves consisting of a combination of longitudinal and shearing waves traveling at acute angles to the axis of the waveguide and satisfying the following boundary condition: mechanical stress at the waveguide surface is zero. The waveguide can terminate with a concentrator that concentrates the elastic wave in a predetermined area of the material.

A very important advantage of this invention is that elastic waves can be made to impinge only on the predetermined areas of the scribe line. This facilitates making alternating separating and non-separating cuts in a single process cycle. One example of such a cut is shown in FIG. 6, where in one process cycle, the cut starts and finishes with a non-separating scribe 3, i.e., without using elastic waves to deepen the scribe line, while the rest of the cut extends through the material to form a separating crack 8. First, this method enables making separating crosscuts without degrading the quality of the cut at intersections of the cutting lines and without creating additional scribing at the intersections. Second, this ensures high accuracy and quality of the cut because the sheet retains its initial dimensions and integrity until the whole sheet is completely cut into separate elements.

Yet another advantage of the proposed method for cutting brittle non-metallic materials is the ability to perform a separating cut at a certain angle relative to the plane perpendicular to the material surface. This is because the direction of the source of elastic waves 6 and direction of application of the cutting tool 2 are shifted relative to the plane perpendicular to the material surface 1 (FIG. 7). As a result of this displacement, the path of separating cut 9 is inclined at angle φ to the direction perpendicular to the surface of the material. Such a cutting method gives very good results for cutting disks or other items with a closed cutting pattern because it enables easy detaching of the cut out items from the material. The angle of incline can be so small that it has substantially no effect on the accuracy of the cutting.

The described cutting method for brittle non-metallic materials can be used to cut not only single-layer materials but also laminated sheets. FIG. 8 shows a schematic for cutting sheet 1 glued to sheet 10 by adhesive 11. In this instance, elastic wave 5 expands from the side of sheet 10 and, reaching heated area 3, deepens the notch to separating cut 8 of sheet 1.

Sometimes the placement of the waveguide and elastic wave concentrator on the opposite surface of the material is complicated or impossible. However, it is possible to direct elastic waves into the material from the scribed side 3 in sheet 1 as well (FIGS. 10 and 11). Everything depends on the construction and type of elastic wave source. In this example, two waveguides 6 and two concentrators 12 are used to concentrate two elastic waves from the side of the material upon which tool 2 impinges, along opposite sides of the scribe line 3. Additional action of two elastic wave concentrators along opposite sides of the scribe line create additional volumetric stresses that lead to deepening of the scribe line or to a separating cut 8.

Let us examine one of the simplest implementations of the proposed method, namely, deepening of scribe line 3 or performing a separating cut by applying mechanical waveguide 6 and concentrator 12 of elastic wave, arising from the mechanical action of hammer 13 (FIG. 9). Mechanical waveguide 6 can be made both rectilinear and curvilinear, as shown in FIG. 9. Such design of the waveguide precludes transfer of mechanical impact from impactor 13 directly to the material surface 1. In this instance, waveguide 6 is made as a curved metal rod terminating in concentrator 12, a cone with a certain angle at the vertex. The cone vertex is shaped as a hemisphere, which can be made by pressing in a steel sphere. This ensures a point contact of concentrator 12 with the material surface 1. The concentrator is set perpendicular to the material surface 1 and is placed strictly along the notch line 3 in the area of its formation. The constant mechanical action of the concentrator with force P₁ on the material surface 1 should be minimal, should not cause any deformations of the material, and should ensure only contact of the concentrator with the material surface 1. The elastic wave in waveguide 6 and the concentrator is created by interaction of impactor 13 with the end face of waveguide 6 with force P₂. Impact with waveguide 6 forms in it deformation elastic waves that propagate along waveguide 6 and accumulate in the concentrator. The energy of the elastic deformation at the contact point of the concentrator with the material surface 1 transfers into the material 1 and, reaching the vertex of scribe line 3, the transverse waves cause scribe 3 to extend down within the material, all the way to the separating cut 8.

In several instances, the combined action of elastic wave sources simultaneously from two sides of the cut material 1 is effective (FIG. 12). This embodiment is most effective for making a separating cut through thick sheets of material.

FIG. 13 shows one of the embodiments of waveguides 6 with concentrators 12 for acting on material 1 from the side of scribe line 3.

The frequency range of the elastic waves that can deepen the notch may be exceedingly broad: from several Hz to high-frequency oscillations. Very different sources of elastic waves can be used. Thus, the elastic wave source can be located either on the scribed side of the surface or on the opposite side of the surface, depending on the type of elastic wave source used and design specifications of the equipment used.

In another embodiment, the method for cutting brittle non-metallic materials consists of the following.

Various known cutting methods involving heating the surface of a sheet of brittle non-metallic material, for example, glass sheet 1, with an elliptical laser beam 2, result in high compression stresses σ_{c} in the area impinged on by the beam. However, these stresses are insufficient to destroy the material. The reason for this is that compressive strength of the material is much greater than its tensile or bending strength. For example, the compressive strength of glass is 8-10 times greater than the tensile strength. Compression stresses increase as the beam traverses the path of the cut and reach their maximal value after the beam is gone. Compression stresses σ_{c} in the surface layers of material 1 reverse their sign when the heat-affected area is quenched using a spot cooling medium 4, for example, an air-water stream supplied using a nozzle. Microcrack 3, which expands behind the “heat-cold” boundary and follows the relative displacement of the beam and the spot cooling medium at rate ν, is generated in the material by the action of the resulting tensile stresses σₜ. A spot cooling medium removes heat only from a thin surface layer. Therefore, volumetric compression stresses σ_{c} that persist deeply inside the heated material prevent further propagation of crack 3 into the material.

A completely different picture is observed if the heated area is cooled using an elongated slotted cooling device (FIG. 14). Like in the preceding instance, the maximal compression stresses are located in the surface layers of the material immediately after the cooling medium has passed. A shallow microcrack forms through the action of large surface tensile stresses σₜ in the initial moment after the cooling agent is applied. As the supply of coolant to the heated area continues, surface tensile stresses decrease. However, volumetric tensile stresses arise and lead to an expansion of the crack into the material up to the formation of a separating crack 8.

The coolant can be a stream of air, a special gas mixture, an air—gas mixture, a gas—liquid mixture, for example, an air-water mixture, or various other coolants. The number of components in the applied mixture and the rate of applying the mixture to the heated area are regulated and controlled depending on the thickness of the material and its properties in addition to the requirements and limitations imposed on the cutting process. For example, in some cases water can not be used as a coolant because it can contaminate the cut material or special coatings and structures formed on the surface of the material.

The mechanism for applying the coolant should be configured as a multistage with the ability for independent control of the separate stages during the cutting process in order to control the expansion depth of the crack. This same method should be used to cut materials of different thickness or materials with different properties. This means that the number of working stages in the cooling medium, for example, a multistage slotted nozzle, is selected depending on the thickness of the material and its thermal conductivity. FIG. 15 shows a schematic diagram of directed cutting at a predetermined depth using multi-stage controlled cooling. Laser beam 2, which is formed elongated relative to the displacement direction using an optical system, is directed onto the material surface 1. The multistage slotted nozzle 14, which supplies coolant 4 to the heated area, is placed behind the laser beam and consists in this instance of five independent stages 14-I, 14-II, 14-III, 14-IV, and 14-V, which are controlled by a computer. If only the first stage of the nozzle 14-I is operating, then a crack of depth δ₁ forms in the material. If two stages of nozzle 14 are operating, 14-I and 14-II, then the crack of depth δ₂ expands in the material. If three stages are operating, 14-I, 14-II, and 14-III, then the crack deepens to the value δ₃. Increasing the number of cooling stages to the required value, for example, to five stages, can produce a through crack of depth δ₅.

Actual examples of cutting using the first variant of the invention are provided below.

### EXAMPLE 1

Glass sheets having a thickness of 0.7 mm were used as the material for cutting. A diamond pyramid as the cutting tool with a facet cutting angle of 120 angular degrees was used to make the scribe. A two-coordinate table with a travel of 500×400 mm that provided for a displacement rate up to 500 mm/s was used as the displacement device. A source of elastic waves acted on the opposite surface of the sheet. For this, a mechanical-wave concentrator, consisting of a round rod 5 mm in diameter and terminating in a cone, the vertex of which terminated in a hemisphere 1.5 mm in diameter, was set in contact with the material surface on the other side of the area affected by the laser beam. The force of the concentrator pressed against the quartz glass surface was P₁=2-4 G and was designed to ensure constant contact of the concentrator and material during the cutting, i.e., so the concentrator would track micro irregularities on the sheet surface. The end of the waveguide is treated with a tapper with force P₂=45 G and frequency 200 Hz, which formed deformation elastic waves in the concentrator. The diamond pyramid made a cut in the shape of a scratch of depth 0.07 mm as the glass sample was displaced at a rate of 350 mm/s. The action of the elastic wave in the area of scribe formation extended the scribe line into a separating cut. Treating the end face of the waveguide with a tapper of force 25 G and frequency 250 Hz deepened the scribe line to 0.5 mm at a rate of 350 mm/s.

### EXAMPLE 2

A sheet of glass having a thickness of 1.1 mm was cut into disks of outer diameter 65 mm and inner diameter 20 mm. Scribing was done using a hard-alloy roller having a diameter of 7 mm with a grinding angle of 95 angular degrees. The device described in the previous example was used as the source of elastic waves. The hard-alloy roller and elastic wave concentrator are shifted relative to each other in the plane perpendicular to the material surface by 0.025 mm to the side of the larger tolerance for the predetermined geometric size. This ensured that an inclined separating cut formed, which in turn ensured that the seam of the inner and outer parts of the disk were separated without damaging the material of the main working part of the disk.

### EXAMPLE 3

A quartz glass sheet having a thickness of 2.2 mm was cut. Scribing was done with a hard-alloy roller with a grinding angle of 115 angular degrees. Two elastic wave concentrators located at a distance of 3 mm from each other on opposite sides of the scribe line were used simultaneously behind the roller on the scribed side of the glass to deepen the scribe line to a depth of 0.15 mm. The end faces of the waveguides were treated with a tapper with force 80 G and frequency 150 Hz. A separation cut was made at a cutting rate of 300 mm/s.

In all three examples mentioned above, sources and concentrators of deformation elastic waves that were formed by mechanical action of the tapper on the waveguide end were used. Thus, as already emphasized above, there is no mechanical action on the material surface from the side of the concentrator. Other sources of elastic waves were successfully tested with positive results.

### EXAMPLE 4

Quartz glass sheets of thickness 0.8 mm were used as the material to be cut. A device containing a multi-mode CO₂ laser of power 85 W and a two-coordinate table of travel 550×650 mm that enabled a displacement rate up to 750 mm/s were used to perform the cutting tests. The laser beam was focused on the material surface using spherical—cylindrical zinc-selenide optics that gave a radiation power density on the quartz surface of about 20 W/mm². The elastic wave source acted on the opposite surface of the quartz sheet. For this, a mechanical-wave concentrator was brought into contact with the material surface opposite the area affected by the laser beam, the concentrator being a round rod of diameter 5 mm terminating in a cone, the vertex of which terminated in a hemisphere of diameter 1.5 mm. The force of the concentrator pressed against the quartz glass surface was P₁=2-4 G and was designed to ensure constant contact of the concentrator and material during the cutting, i.e., so the concentrator would track microirregularities on the sheet surface. The end of the waveguide was treated with a tapper with force P₂=40 G and frequency 300 Hz, which formed deformation elastic waves in the concentrator. The laser beam formed microcracks of depth 0.09 mm as it moved along the surface of quartz glass at a rate of 350 mm/s. Elastic wave impinging on the crack formation area propagated the crack to a separation cut. Cutting and breaking were performed simultaneously at a rate of 350 mm/s.

It is interesting to use pulse lasers to generate elastic waves that deepen the crack in the material by heating the surface or bulk of the material. Although this leads to a certain rise in the price of the equipment, in some cases such an approach is justified. The results of such a method are given in example 5.

### EXAMPLE 5

The materials for cutting were glass sheets having a thickness of 0.7 mm. Tests were conducted using a device containing one multi-mode CO₂ laser of 100 W power for scribing and a second pulse CO₂ laser of power up to 85 W with a radiation frequency regulated up to 40 MHz to form the elastic wave in the material. The glass was moved using a two-coordinate table of travel 670×720 mm that enabled a displacement speed up to 750 mm/s. The radiation of the first laser was focused on the material surface using zinc-selenide spherical—cylindrical optics that ensured an elliptical beam of length 45 mm was formed. A scribe having a depth of 0.12 mm was made as the glass was moved at a rate of 350 mm/s using the laser beam and a cooling medium. The pulse-laser radiation was generated using an optical system of two beams of diameter 1 mm located on opposite sides of the scribe line at a distance of 1.5 mm from each other. The action of the elastic wave on the scribe formation area at a frequency of 100 Hz deepened the scribe to a separating cut. The cutting and breaking were performed simultaneously at a rate of 350 mm/s.

Because the effect of the elastic wave is concentrated in a very narrow limited volume of material in the area of laser scribing, neighboring cuts can be made in close proximity to each other. Cuts of square or rectangular work pieces can be made, the minimal size of which can be no larger than the thickness of the starting material. For example, square pieces were cut from glass of thickness 1.1 mm with dimensions 1.1×1.1 mm, or pieces of dimension 2.5×2.5 mm from glass of thickness 3 mm.

Actual examples of the cutting of various brittle non-metallic materials using the second inventive method are given below.

### EXAMPLE 6

A sheet of borosilicate glass having a thickness of 0.7 mm was cut using radiation from a CO₂ laser with a special mode structure and wavelength 10.6 μm and power 95 W. The laser radiation was focused on the glass surface using a ZnSe spherical—cylindrical objective that formed an elliptical beam of length 45 mm in the cutting area. The cut was made in the following sequence. The glass sheet was attached to the two-coordinate table using a vacuum. The two- coordinate table was moved with the glass sheet attached to it at the predetermined rate. The laser radiation was directed onto the surface of the moving sheet. Coolant was supplied behind the laser beam as an air—gas mixture using a five-stage slotted nozzle. Each stage of the slotted nozzle had a slit of length 9 mm that was oriented along the cutting line. The glass sheet was quenched under different conditions:

1. Quenching by a traditional single-nozzle fitting;

2. Quenching by a single slotted stage of a five-stage nozzle;

3. Quenching by two slotted stages of a five-stage nozzle;

4. Quenching by three slotted stages of a five-stage nozzle;

5. Quenching by four slotted stages of a five-stage nozzle;

6. Quenching by five slotted stages of a five-stage nozzle.

The maximal rate of the separating cut and the maximal rate of the cut with a microcrack were determined for each instance. The results of the tests are given in Table I. The following designations are used in Table I:

letter M—non-separating cut with a microcrack;

letter C—separating cut;

symbol“-”—no cut

TABLE I

| Examples | | Cutting rate, mm/s | | | | | | |
|---|---|---|---|---|---|---|---|---|
| No. | Nozzle type | 250 | 300 | 350 | 400 | 450 | 500 | 550 |
| 1 | Single-nozzle | M | M | — | — | — | — | — |
| 2 | 1-stage slotted | C | C | M | M | — | — | — |
| 3 | 2-stage slotted | C | C | C | M | M | — | — |
| 4 | 3-stage slotted | C | C | C | C | M | M | — |
| 5 | 4-stage slotted | C | C | C | C | C | M | — |
| 6 | 5-stage slotted | C | C | C | C | C | C | M |

### EXAMPLE 7

A sapphire material having a diameter of 50.8 mm and thickness of 0.43 mm was used as the material for cutting. A multi-mode CO₂ laser with a special mode structure power of 75 W was used for the cutting. The laser beam was formed on the material surface as a beam having a length of 7 mm elongated in the cutting direction using a two-lens objective. The coolant was a stream of compressed moistened gas supplied using a slotted nozzle of slit length 9 mm. The sapphire material was cut through at a rate from 350 to 700 mm/s. Then the cutting was performed at an increased rate by scribing at a depth that decreased as the sheet displacement rate increased relative to the laser beam and coolant. REPLACEMENT PAGE (RULE 26) The maximum rate of the non-separating cut was 1100 mm/s.

The present invention can be used in various areas of technology for highly accurate and high-throughput cutting of a wide range of materials both through the whole thickness of the material and at any predetermined depth. Alternation of separating cuts and non-separating cuts at a predetermined depth is possible during cutting along a single cutting path. The invention appears to be highly effective for making separating cuts in glass having a thickness ranging from 0.1 to 20 mm, including making such cuts during the glass manufacturing process. Furthermore, crosscutting is possible without degrading the quality of the cuts at the intersections. It is possible to cut single-layer materials and laminated sheets, which is exceedingly important when cutting such items as flat-panel displays (FPD), including liquid-crystal displays (LCD). Yet another distinctive feature of the present invention is the ability to make a separating cut at a right angle to the material surface and at an inclined angle to the surface of the cut material. The latter method is very important for cutting disks or other items with a closed pattern.

1. A method for cutting brittle non-metallic materials, comprising forming a scribe along the path of the cut by heating the surface of the material along the path of the cut using a laser beam, and additionally acting on the surface of the material, the method characterized by the additional action on the surface of the material being performed in the area of scribe formation by at least one source of elastic waves, said waves being concentrated in the bulk of the material in the area of the scribe formation along the path of the cut, the amplitude and frequency of elastic waves being selected to either deepen the scribe to a predetermined depth or make a through cut.

2. The method of claim 1, wherein, after heating the surface of the material along the scribe line with a laser beam, a heated area is cooled using a cooling medium while impinging on the area of application of the coolant with elastic waves.

3. The method of claim 1, wherein said scribe is applied along the path of the cut by heating the material surface along the path of the cut with two laser beams located on the material surface at a predetermined distance from each other in a direction perpendicular to the direction of the relative displacement of the laser beams and material.

4. The method of any of claims 1-3, wherein the source of elastic waves comprises radiation from a pulse laser source, said material being opaque to said radiation.

5. The method of claim[s] 1[-4], wherein said elastic wave impinges on the path of the cut after completion of the scribe formation.

6. The method of claim[s] 1[-5], wherein said elastic waves impinge on the material surface only in predetermined areas of the material along the path of the cut.

7. The method of claim[s] 1[-8], wherein the line impinged on by the source of elastic waves and the path of the cut are displaced relative to each other in the plane perpendicular to the material surface.

8. The method of claim[s] 1[-9], wherein two elastic waves are concentrated simultaneously on the side of the surface of the material having said scribe formed thereon following the scribing tool on opposite sides of the path of the cut.

9. The method of claim 8, wherein an elastic wave is concentrated simultaneously in the material bulk in the area of scribe formation, impinging on the opposite side of the surface of the material in the area located between the areas impinged on by said elastic waves concentrated on the side of the surface of the material having said scribe formed thereon..

10. A method for cutting brittle non-metallic materials, comprising forming a scribe along the path of the cut and additionally acting on the material surface, the method characterized by said scribing being formed by heating the material surface along the path of the cut formed thereon with a laser beam and by locally quenching the heated area, wherein the additional action on the surface of the material comprises subsequent cooling of each point lying on the path of the cut in the heated area using an cooling device disposed along the path of the cut for a period of time commensurate with the duration of heat application at that point.

11. The method of claim 10, wherein the cooling time is determined depending on the thickness of the material, its thermophysical properties, and the desired depth of the cut using an elongated multi-stage cooling apparatus disposed along the path of the cut.

12. The method of any of claims 10-11, wherein cooling of each point lying on the path of the cut in the heated area is performed by an elongated slotted cooling apparatus disposed along the path of the cut.
